(19) United States
(12) Patent Application Publication
(10) Pub. No.: US 2018/0331400 A1
(43) Pub. Date: Nov. 15, 2018

(54) LITHIUM BATTERY

(71) Applicant: STMicroelectronics (Tours) SAS, Tours (FR)

(72) Inventor: Delphine GUY-BOUYSSOU, Luynes (FR)

(73) Assignee: STMicroelectronics (Tours) SAS, Tours (FR)

(21) Appl. No.: 15/976,092

(22) Filed: May 10, 2018

(30) Foreign Application Priority Data
May 11, 2017 (FR) 1754148

(51) Int. Cl. H01M 10/52; H01M 10/0525; H01M 10/052; H01M 10/0562; H01M 4/525; H01M 2/02

(52) U.S. Cl. CPC H01M 10/526; H01M 10/0525; H01M 10/052; H01M 2004/028; H01M 4/525; H01M 2/0287; H01M 2300/0068; H01M 10/0562

(57) ABSTRACT

A lithium-metal or lithium-ion battery includes a stack of a cathode layer made of LiCoO₂, an anode layer and an electrolyte layer made of LiPON positioned between anode and cathode layers. An encapsulating layer covers the stack. The battery further includes an interface layer made of a material that is able to capture oxygen generated during charge/discharge cycles of the battery. This interface layer is placed under the encapsulating layer.

### PRIORITY CLAIM

This application claims the priority benefit of French Application for Patent No. 1754148, filed on May 11, 2017, the disclosure of which is hereby incorporated by reference in its entirety to the maximum extent allowable by law.

### TECHNICAL FIELD

The present application relates to a lithium battery.

### BACKGROUND

It is known to use lithium batteries in electronic devices such as laptops, mobile phones and tablet computers.

There are a number of types of lithium battery such as a lithium-ion battery, a lithium-polymer battery or a lithium-metal battery. Each of these types of battery is characterized by the materials composing the various elements of the battery.

A lithium-metal or lithium-ion battery may be formed from a cathode made of lithium cobalt oxide (LiCoO₂), an electrolyte made of lithium phosphorus oxynitride (LiPON) and an anode. In the case of a lithium-metal battery, the anode is made of lithium (Li). In the case of a lithium-ion battery, the anode is a lithium intercalation compound or a compound that allows an alloy to be formed with lithium, for example LiFePO₄, graphite, Li₄Ti₅O₁₂ or a TiSi or TiGe alloy. The whole lot is encapsulated in a protective layer. LiPON is a solid electrolyte allowing thin and flexible lithium batteries to be produced. The small thickness of these batteries allows them to be integrated into thin devices. The flexibility of these batteries allows them to be integrated into flexible devices. For example, such batteries may be integrated into the strap of a wristwatch in order to power the electronic circuitry of the watch. Moreover, it is also possible to stack these batteries to form a compact module in which the batteries are connected in series and/or in parallel.

In known lithium-metal and lithium-ion batteries using LiCoO₂ by way of cathode material, protuberances frequently form in the encapsulating layer during charging cycles and in particular during the first charging cycle. These protuberances result from gas bubbles trapped under the encapsulating layer and can cause various problems. When the battery is deformed, for example when it is bent, cracks may form in the encapsulating layer, thus exposing the anode, cathode and/or electrolyte layers of the battery to open air. These protuberances also make it difficult, or even impossible, to stack a plurality of batteries to produce a compact module of a plurality of batteries connected in series and/or parallel.

The present application aims to decrease, or even suppress, these protuberances.

### SUMMARY

In an embodiment, a lithium-metal or lithium-ion battery comprises a stack including a cathode layer made of LiCoO₂, an anode layer and an electrolyte layer made of LiPON between the anode and cathode layers; an encapsulating layer covering the stack; and an interface layer made of a material that is configured to capture oxygen and placed under the encapsulating layer.

According to one embodiment, the interface layer is made of a material configured to capture oxygen via an oxidation chemical reaction.

According to one embodiment, said material is a metal chosen from the group comprising copper, aluminum, zinc and titanium.

According to one embodiment, said material is a substoichiometric metal oxide.

According to one embodiment, said material is aluminum oxide.

According to one embodiment, the encapsulating layer is adhesively bonded to the stack by an adhesive layer.

According to one embodiment, the encapsulating layer comprises an aluminum film coated with a film of polyethylene terephthalate.

According to one embodiment, the encapsulating layer has a thickness smaller than 150 μm.

### BRIEF DESCRIPTION OF THE DRAWINGS

These features and advantages, and others, will be described in detail in the following description of particular embodiments, which description is given without limitation and with reference to the appended figures, in which:

FIG. 1 is a cross-sectional view of an example of a lithium-metal battery with a cathode made of LiCoO₂; and

FIG. 2 is a cross-sectional view of one embodiment of a lithium-metal battery with a cathode made of LiCoO₂.

### DETAILED DESCRIPTION

The figures have not been drawn to scale and, for the sake of clarity, only those elements that are useful to understanding the described embodiments have been shown and described in detail. In particular, the topology, as seen from above, of the anode and cathode contacts of the batteries described below has not been described in detail since it is within the capabilities of a person skilled in the art to adapt this topology to the targeted application and in particular depending on the way in which the battery must be connected.

In the following description, when the terms “left”, “right”, “upper”, “lower”, “flank”, etc. are used, reference is being made to the orientation of the elements in question in the corresponding figures. Unless otherwise specified, the expression “about” means to within 10% and preferably to within 5%.

For a battery, the term “anode” means the negative electrode and the term “cathode” means the positive electrode.

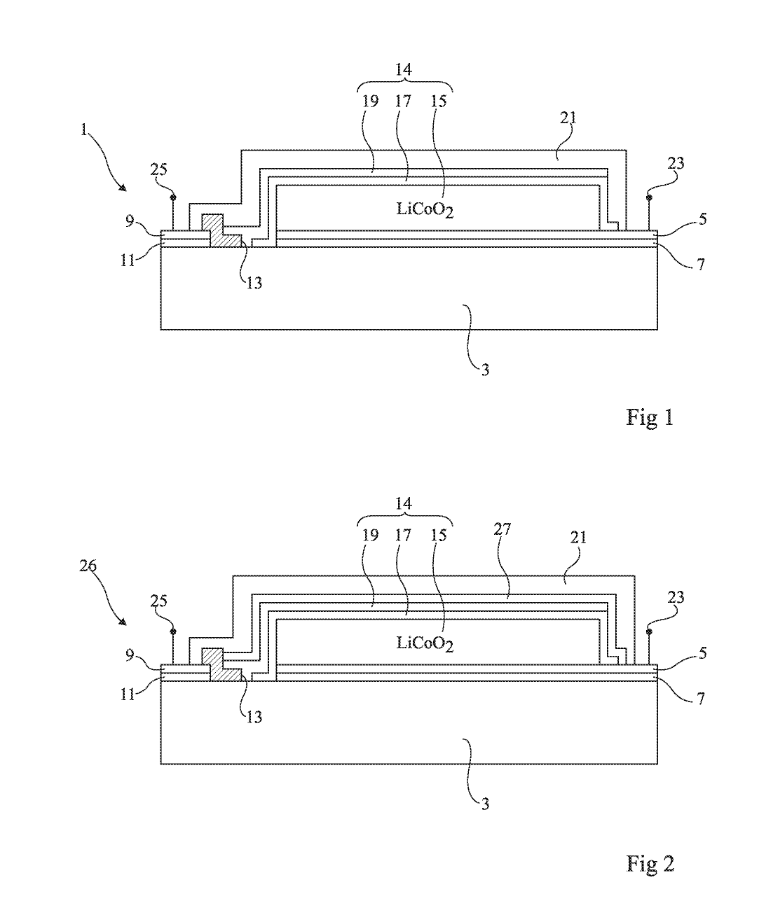

FIG. 1 is a cross-sectional side view of an example of a lithium battery 1. The battery 1 is formed on a carrier 3, for example a substrate made of a dielectric such as zirconium dioxide (ZrO₂).

On most of the carrier 3 (on the right in the figure) is placed a conductive layer 5 that is optionally arranged on a binding layer 7. The conductive layer 5 is made of a metal, for example of platinum, and has a thickness comprised between 50 nm and 10 μm and, for example, of about 100 nm. The binding layer 7 is made of lithium cobalt oxynitride (LiCoON) and has a thickness comprised between 50 nm and 10 μm and, for example, of about 1 μm. The conductive layer 5 is a cathode contact layer. On a small portion of the carrier 3 (on the left in the figure) is placed a conductive layer 9 that is optionally arranged on a binding layer 11. The material of the conductive layer 9 is preferably identical to that of the conductive layer 5. The material of the binding layer 11 is preferably identical to that of the binding layer 7. A metal layer section 13, which is for example made of copper, straddles one end of the conductive layer 9 and the carrier 3. The layer 13 has a thickness comprised between 50 nm and 10 μm and is, for example, about 500 nm. The layers 9 and 13 form an anode contact.

On most of the conductive layer 5 rests a stack 14 comprising a cathode layer 15 made of lithium cobalt oxide (LiCoO₂), an electrolyte layer 17 made of lithium phosphorus oxynitride (LiPON), and an anode layer 19 that is, for example, made of lithium (Li). The lower face of the cathode layer 15 makes contact with the cathode contact layer 5. The cathode layer 15 has a thickness comprised between 2 and 50 μm and, for example, of about 10 μm. The electrolyte layer 17 is between the cathode layer 15 and the anode layer 19 and separates these layers 15 and 19 from each other. The lower face of the layer 17 makes contact with the layer 15 and the upper face of the layer 17 makes contact with the layer 19. In the example shown, the electrolyte layer 17 juts out from one side of the stack 14 (to the right of the layer 15 in the figure), on the conductive layer 5, and on another side of the stack 14 (to the left of the layer 15 in the figure), on the carrier 3, without making contact with the layer 13. The electrolyte layer 17 has a thickness comprised between 0.5 and 5 μm and for example of about 2 μm. The anode layer 19 covers most of the electrolyte layer 17. The anode layer 19 juts out from one side of the stack 14 (to the left in the figure) and extends as far as to the copper layer 13. The anode layer 19 has a thickness comprised between 50 nm and 20 μm and, for example, of about 5 μm.

An encapsulating layer 21 covers the various elements of the battery and in particular the layers 15, 17 and 19 of the stack 14 in such a way as to leave accessible only a portion of the conductive layer 5 and a portion of the conductive layer 9. The free portion of the layer 5 forms a zone allowing for a cathode contact redistribution 23 and the free portion of the layer 9 forms a zone allowing for an anode contact redistribution 25.

The encapsulating layer 21, for example, consists of an aluminum film covered with a film of polyethylene terephthalate (PET), also known by the abbreviation PET-alu. When the layer 21 is of PET-alu, the aluminum film is always separated from the anode layer 19 by at least one adhesive layer. For example, the aluminum film is adhesively bonded to the stack 14 by an adhesive film, and the PET film is adhesively bonded to the aluminum film by an adhesive layer. The encapsulating layer 21 is, for example, deposited by lamination. The encapsulating layer 21 has a thickness comprised between 5 and 150 μm and for example of about 100 μm. Such a PET-alu encapsulating layer 21 is flexible and therefore particularly suitable for lithium batteries intended to conform to the shape of the electronic devices into which they will be integrated.

As indicated above, during the charging cycles of a battery of the type of that in FIG. 1, protuberances are liable to form in the encapsulating layer because of gas bubbles forming under the encapsulating layer 21. By way of example, for a battery 1 having the shape of a rectangle of 2.5 cm length and 2 cm width, these protuberances may have a height of approximately 1 to 5 mm and a diameter of approximately 1 cm.

FIG. 2 is a cross-sectional side view of one embodiment of a lithium battery 26, in which battery the formation of such protuberances is decreased or even suppressed.

The battery 26 comprises the same elements, referenced by the same references, as the battery 1 of FIG. 1 and furthermore comprises an interface layer 27 made of a material that is able (i.e., is configured) to capture oxygen. The interface layer 27 is inserted between the stack 14 and the encapsulating layer 21. Preferably, the interface layer 27 entirely covers the stack 14.

Tests have shown that oxygen is released by the cathode layer 15 made of LiCoO₂ during battery charging cycles and mainly during the first charging cycle. In the battery 1 of FIG. 1, the released oxygen passes through the electrolyte layer 17 and the anode layer 19 before accumulating under the seal-tight encapsulating layer 21 where the formation of bubbles leads to the appearance of protuberances in the encapsulating layer 21. In the battery 26 of FIG. 2, when the oxygen released by the layer 15 of LiCoO₂ reaches the interface layer 27, it reacts with the material of the layer 27, with which it is liable to combine. As a result, the number and/or size of the bubbles and therefore of the protuberances that form is greatly decreased, for example by at least 40%, with respect to the case of a battery of the type of that in FIG. 1 devoid of interface layer 27.

The layer 27 is made of a material liable to oxidize. This material is, for example, a metal chosen from the group comprising copper, titanium, aluminum and zinc. By way of example, the thickness of an interface layer 27 made of copper is comprised between 100 nm and 1 μm and is, for example, 500 nm. In the case of a metal layer 27 made of copper or titanium of a thickness of 100 nm, tests have shown a decrease of 42% in the number and/or size of the bubbles with respect to the case of a battery of the type of that in FIG. 1. The material of the layer 27 may also be a substoichiometric, i.e. under oxidized, metal oxide, for example aluminum oxide Al₂Oₓ where x is strictly lower than 3. By way of example, a layer 27 made of Al₂O₂ may be deposited by atomic layer deposition (ALD), chemical vapor deposition (CVD) or cathode sputtering (PVD), and may have a thickness comprised between 10 and 100 nm.

Particular embodiments have been described. Various variants and modifications will seem obvious to those skilled in the art. In particular, although an embodiment has been described in which the encapsulating layer is of PET-alu, this encapsulating layer could be made of other materials, for example a film of polyvinylidene chloride (PVDC) coated with a film of mica.

The carrier may either be made of an insulator, for example of mica or of another ceramic such as zirconia or alumina, or be made of a conductor, for example of aluminum or another metal, coated with an insulating layer, or indeed of a semiconductor, for example of silicon, coated with an insulating layer.

Furthermore, an interface layer 27 such as described with reference to FIG. 2 may be provided in lithium batteries in which the cathode material is LiCoO₂ and in which the configuration of the layers 5, 9, 15, 17 and/or 19 is different from that illustrated in FIG. 2.

1. A lithium-metal or lithium-ion battery, comprising:
a stack including a cathode layer made of LiCoO₂, an anode layer and an electrolyte layer made of LiPON between the anode and cathode layers;
an encapsulating layer covering the stack; and
an interface layer made of a material that is configured to capture oxygen and which is placed under the encapsulating layer.

2. The battery according to claim 1, wherein the material configured to capture oxygen operates to capture oxygen via an oxidation chemical reaction.

3. The battery according to claim 2, wherein said material is a metal selected from the group consisting of: copper, aluminum, zinc and titanium.

4. The battery according to claim 2, wherein said material is a substoichiometric metal oxide.

5. The battery according to claim 4, wherein said material is aluminum oxide.

6. The battery according to claim 1, wherein the encapsulating layer is adhesively bonded to the stack by an adhesive layer.

7. The battery according to claim 1, wherein the encapsulating layer comprises an aluminum film coated with a film of polyethylene terephthalate.

8. The battery according to claim 1, wherein the encapsulating layer has a thickness smaller than 150 μm.

9. The battery according to claim 1, wherein the interface layer is placed between the stack and the encapsulating layer.

10. A method for capturing oxygen generated within a sealed lithium-metal or lithium-ion battery during charge/discharge cycles comprising capturing said oxygen via an oxidation chemical reaction with a material placed within the sealed lithium-metal or lithium-ion battery.

11. The method according to claim 10, wherein said material is a metal selected from the group consisting of: copper, aluminum, zinc and titanium.

12. The method according to claim 10, wherein said material is a sub stoichiometric metal oxide.

13. The method according to claim 12, wherein said material is aluminum oxide.

14. A lithium-metal or lithium-ion battery, comprising:
a stack including a cathode layer made of LiCoO2, an anode layer and an electrolyte layer made of LiPON between the anode and cathode layers;
an encapsulating layer covering the stack; and
an interface layer made of a material that is configured to capture oxygen, said interface layer positioned between the encapsulating layer and the stack;
wherein said material is a substoichiometric metal oxide.

15. The battery according to claim 14, wherein the material configured to capture oxygen operates to capture oxygen via an oxidation chemical reaction.

16. The battery according to claim 14, wherein said material is aluminum oxide.

17. The battery according to claim 14, wherein the encapsulating layer is adhesively bonded to the stack by an adhesive layer.

18. The battery according to claim 14, wherein the encapsulating layer comprises an aluminum film coated with a film of polyethylene terephthalate.

19. The battery according to claim 14, wherein the encapsulating layer has a thickness smaller than 150 μm.
